(19) United States
(12) Patent Application Publication
(10) Pub. No.: US 2003/0191229 A1
(43) Pub. Date: Oct. 9, 2003

(54) Resin composition

(76) Inventors: Nami Ikeda, Narashino-shi (JP); Akihiro Ito, Narashino-shi (JP); Koichi Kobayashi, Narashino-shi (JP); Shigeru Yanagisawa, Narashino-shi (JP)

Correspondence Address: JORDAN AND HAMBURG LLP, 122 EAST 42ND STREET, SUITE 4000, NEW YORK, NY, 10168, US

(21) Appl. No.: 10/393,649

(22) Filed: Mar. 20, 2003

(30) Foreign Application Priority Data
Mar. 26, 2002 (JP) 2002-85504

(51) Int. Cl. C08K 3/04

(52) U.S. Cl. 524/496; 524/495

(57) ABSTRACT

To provide a resin composition having superior rigidity and conductivity at a low price. Movers 11a and 11b are produced as a conductive resin composition by resin molding of a resin composition obtained by melt kneading vapor grown carbon fibers (VGCF) and carbon fibers with a thermoplastic resin such as PPS (polyphenylene sulfide). Among the four external surfaces of each mover, a plurality of convexes 12 extending to the direction perpendicular an optical axis A direction of an electrostatic actuator 3 are formed on the opposing surfaces to an upper stator 21a and a lower stator 21b. Accordingly, the carbon fibers having conductivity are aligned over the whole of each mover, especially even in the fine convexes 12 provided on the external surface thereof, and the VGCF is uniformly dispersed and aligned even in portions where the carbon fibers are not aligned.

### BACKGROUND OF THE INVENTION

1. Field of the Invention

The present invention relates to a resin composition containing fine carbon fibers.

2. Description of the Related Art

In recent years, resin compositions containing fine carbon fibers such as carbon nanotube, to which rigidity and conductivity are imparted by the carbon fibers, have been studied and developed.

However, the foregoing resin compositions involved a problem such that they are expensive, because a considerable amount of expensive fine carbon fibers such as carbon nanotube is necessary.

### SUMMARY OF THE INVENTION

An object of the invention is to provide a resin composition having superior rigidity and conductivity at a low price.

A resin composition of the invention contains first fine carbon fibers having a fiber diameter of from 1 to 1,000 nm and second fine carbon fibers having a fiber diameter larger than that of the first fine carbon fibers. According to such a construction, the first fine carbon fibers having conductivity are uniformly dispersed and aligned in the resin composition, and the respective fine carbon fibers interfere each other in many portions, so that a resin composition having high conductivity can be obtained. Further, since the first fine carbon fibers are fine such that the fiber diameter is from 1 to 1,000 nm and are uniformly dispersed and aligned even in fine portions, it is possible to impart high conductivity even in such fine portions. In addition, since the resin composition further contains the second fine carbon fibers having a fiber diameter larger than that of the first fine carbon fibers, the rigidity of the conductive resin composition can be reinforced, and the sliding properties thereof can be enhanced, as compared with the case where the resin composition is formed of only the first fine carbon fibers. Moreover, since the content of the expensive first fine carbon fibers can be made low, it is possible to obtain a cheaper resin composition.

When the content of the first fine carbon fibers is higher than that of the second fine carbon fibers, the conductivity and radiation properties can be enhanced in addition to the foregoing effects.

When the content of the second fine carbon fibers is higher than that of the first fine carbon fibers, the rigidity and sliding properties can be enhanced in addition to the foregoing effects. Further, the resin composition can be produced more cheaply.

### BRIEF DESCRIPTION OF THE DRAWINGS

FIG. 1 is a cross-sectional view of an optical device in which the resin composition of the invention is used.

FIG. 2 is an enlarged view of the major portion of FIG. 1.

FIG. 3 is a plan view viewed from the Z1 direction and the Z2 direction of FIG. 2.

FIG. 4 is a cross-sectional view of the V-V line of FIG. 2.

FIG. 5 is a schematic view showing an internal structure of a mover as shown in FIG. 2.

FIG. 6 is a drawing showing the relation between the application pattern of a pulse voltage to a stator electrode and the movement of the two movers shown in FIG. 2 in the case where the movers are moved interlockingly each other.

FIG. 7 is a drawing showing the relation between the application pattern of a pulse voltage to a stator electrode and the two movers shown in FIG. 2 and the movement of the movers in the case where the movers are moved independently.

### DESCRIPTION OF THE PREFERRED EMBODIMENTS

One mode for carrying out the invention will be specifically described based on embodiments as shown in the accompany drawings.

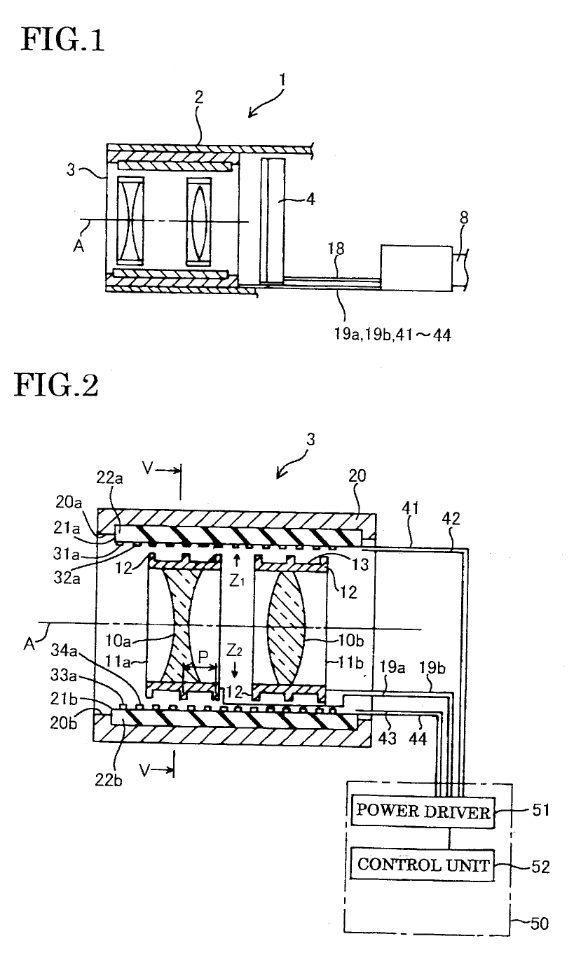

First of all, an optical device in which the resin composition of the invention is used will be described with reference to FIG. 1. As shown in FIG. 1, an optical device 1 is provided with a body of equipment 2, an electrostatic actuator 3 as aligned within the body of equipment 2, and a CCD 4 as one example of an imaging array. In this embodiment, the electrostatic actuator 3 has a function as an objective optical system to regulate the image formation relation of an object beam from an object image with the CCD 4 or the like.

In the forefront of the body of equipment 2, is aligned the electrostatic actuator 3. Further, in the rear of the electrostatic actuator 3, is aligned the CCD 4. An image signal as converted by the CCD 4 is transferred into an external device 50 as described later by a lead wire 18 penetrating within a cable 8.

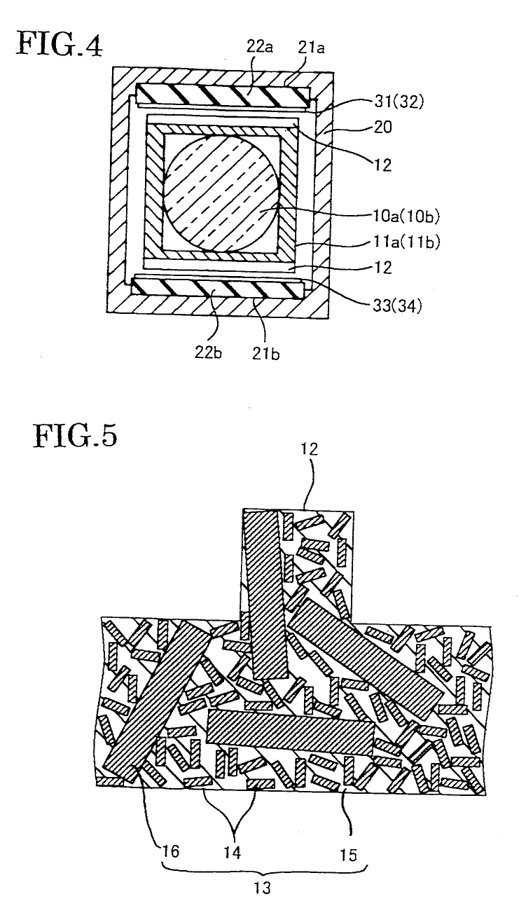

Next, the electrostatic actuator 3 will be described below in detail with reference to FIGS. 2 to 5. As shown in FIGS. 2 and 4, the electrostatic actuator 3 has a frame body 20 having a hollow rectangular parallelepiped shape. As shown in FIG. 2, in an upper internal surface 20a and a lower internal surface 20b of the frame body 20, which are opposite to each other, are fixed an upper stator 21a and a lower stator 21b extending to an optical axis A direction of the electrostatic actuator 3.

As shown in FIGS. 2 and 4, movers 11a and 11b having a hollow, approximately rectangular parallelepiped shape, for which is used the resin composition of the invention, are aligned between the upper stator 21a and the lower stator 21b.

In the hollow portions of the mover 11a and the mover 11b, a concave lens 10a and a convex lens 10b are installed, respectively as one example of the optical element constructing the objective optical system. Incidentally, the alignment sites of electrode-constructing sections (stators) to generate an electrostatic force are not limited to the upper and lower surfaces of the frame body, but the electrode-constructing sections may be aligned on the right and left surfaces of the frame body. Further, the kind and number of the lenses 10a and 10b to be installed in the respective movers are not limited to those as described above but can be properly changed, and a plural number of different lenses may be installed in one mover.

Next, the upper stator 21a and the lower stator 21b will be described below in detail. As shown in FIG. 2, the upper stator 21a and the lower stator 21b have substrates 22a and 22b made of an insulating material such as glass and ceramic, respectively.

On the opposing surfaces of the substrate 22a and the substrate 22b to each other, i.e., the surfaces opposing to the movers 11a and 11b, are provided a first electrode pattern 31 and a second electrode pattern 32, and a third electrode pattern 33 and a fourth electrode pattern 34, respectively.

On the substrate 22 and each of the electrode patterns 31 to 34 are continuously formed an insulating layer (not shown) , and the whole surface of each of the stators 21a and 21b is covered by the insulating layer. Incidentally, an insulating layer is always formed on at least one of the stators 21a and 21b and the movers 11a and 11b; alternatively, a stopper is provided between the stators 21a and 21b and the movers 11a and 11b, such that the electrodes of the both never come into direct contact with each other. The description about the insulating layer and the stopper is omitted.

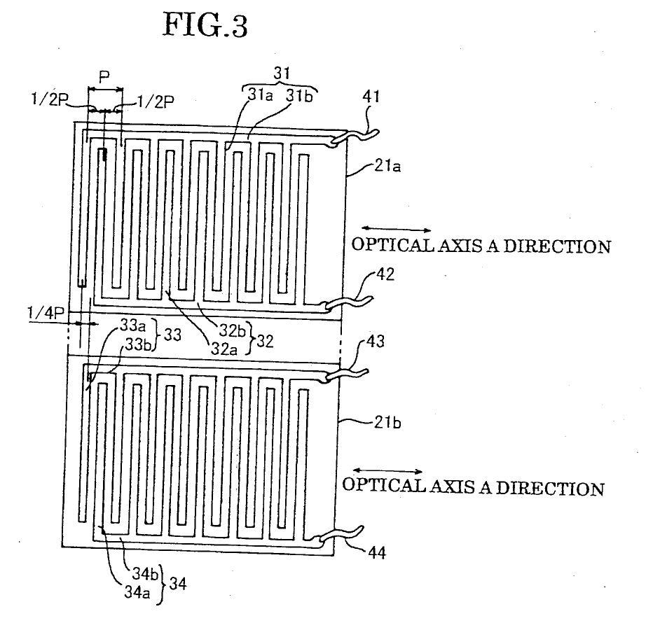

As shown in FIGS. 2 and 3, the first electrode pattern 31 provided on the upper stator 21a is composed of a plurality of stator electrodes 31a extending to the direction perpendicular the optical axis A direction on the surface of the upper stator 21a and a connecting electrode 31b electrically connecting to these plural stator electrodes 31a.

As shown in FIG. 3, the stator electrodes 31a are aligned at equal intervals by a prescribed pitch P in the optical axis A direction. Further, the connecting electrode 31b is connected to one end of each of the stator electrodes 31a. The thus constructed first electrode pattern 31 has a comb shape as a whole.

Each of the second electrode pattern 32, the third electrode pattern 33 and the fourth electrode pattern 34 is composed of a plurality of each of stator electrodes 32a, stator electrodes 33a and stator electrodes 34a and each of a connecting electrode 32b, a connecting electrode 33b and a connecting electrode 34b as aligned in substantially the same mode as in the first electrode pattern 31 and has a comb shape similar to the first electrode pattern 31. In each of the second electrode pattern 32, the third electrode pattern 33 and the fourth electrode pattern 34, each of a pitch between the stator electrodes 32a, a pitch between the stator electrodes 33a and a pitch between the stator electrodes 34a is identical with the pitch P between the stator electrodes 31a of the first electrode pattern 31.

The first electrode pattern 31 and the second electrode pattern 32 are opposed to each other in a deviated state by half of the pitch P in the optical axis A direction and aligned in such a manner that the teeth of one comb are combined with those of the other comb, i.e., the stator electrodes 31a and 32a are alternately aligned in the optical axis A direction.

The third electrode pattern 33 and the fourth electrode pattern 34 provided on the lower stator 21b are aligned in the same mode as in the first electrode pattern 31 and the second electrode pattern 32 provided on the upper stator 21a.

As shown in FIG. 3, the stator electrodes 33a of the third electrode pattern 33 are aligned in a deviated state by a quarter of the pitch P in the axial direction with respect to the stator electrodes 31a of the first electrode pattern 31. Accordingly, the stator electrodes 31a, the stator electrodes 32a, the stator electrodes 33a and the stator electrodes 34a of the first electrode pattern 31, the second electrode pattern 32, the third electrode pattern 33 and the fourth electrode pattern 34 are each aligned in a deviated state by a quarter of the pitch P in the order of 31a, 33a, 32a and 34a along the optical axis A direction.

An end in the axial direction of each of connecting electrodes 31b, 32b, 33b and 34b is connected to each of lead wires 41 to 44, so that a potential of each of the first electrode pattern 31, the second electrode pattern 32, the third electrode pattern 33 and the fourth electrode pattern 34 can be independently regulated from the outside via the lead wires 41 to 44, respectively.

Next, the movers 11a and 11b will be described below. As shown in FIG. 5, the mover 11a is formed by resin molding of a resin composition 13 containing vapor grown carbon fibers (hereinafter referred to as “VGCF”) 14 as the first fine carbon fibers and further containing carbon fibers 16 having a fiber diameter larger than that of the VGCF 14 as the second fine carbon fibers. As shown in FIGS. 2 and 4, among the four external surfaces of the mover 11a, a plurality of convexes 12 extending to the direction perpendicular the optical axis A direction are formed on the opposing surfaces to the upper stator 21a and the lower stator 21b. The convexes 12 have an approximately rectangular parallelepiped shape and are aligned by the same pitch P as the pitch P of the stator electrodes along the optical axis A direction of the electrostatic actuator 3. As shown in FIG. 5, the carbon fibers 16 in the resin composition 13 are also aligned in the fine convexes 12 (in this embodiment, height: 30 μm, width: 30 μm) provided in the mover 11a. Further, the VGCF 14 is also uniformly aligned even in portions where the carbon fibers 16 are not aligned. Thus, the VGCF 14 and the carbon fibers 16 interfere with each other in many portions. Incidentally, the mover 11b has the same construction as in the mover 11a. Here, the shape and size of the convex 12 are not limited to those as described above.

As shown in FIG. 2, the mover 11a and the mover 11b are connected to a lead wire 19a and a lead wire 19b, respectively, so that a potential of each of the mover 11a and the mover 11b can be independently regulated via the lead wires 19a and 19b, respectively. The lead wires 41 to 44 and the lead wires 19a and 19b are connected to a power driver 51 provided in the external device 50 via the cable 8.

Incidentally, in this embodiment, the lead wires 19a and 19b are directly connected to the movers 11a and 11b, but the invention is not limited thereto. For example, it is preferred that a thin metal brush (not shown) is provided on each of the left and right internal surfaces of the frame body 20, thereby ensuring electrical connection to the mover by the metal brush That is, it is possible to satisfy the electrical connection of the mover by physically connecting to the lead wire or by a thin conductive brush.

The upper stator 21a and the lower stator 21b may be formed by adhering a metallic thin film having a prescribed shape to each of the substrates 22a and 22b, or may be formed by laminating a conductive film on each of the substrates 22a and 22b by means of sputtering or vapor deposition and then undergoing patterning by an etching process. Moreover, the insulating layer may be formed by adhering a thin sheet made of a substance having high electrical resistivity onto a conductive film, or may be formed by laminating a silicon oxide film by the sputtering or CVD method. Also, the lead wires 19a and 19b and the lead wires 41 to 44 may be adhered with a conductive adhesive or welded by means of wire bonding.

In this embodiment, the VGCF 14 has a fiber diameter of approximately 200 nm and a fiber length of approximately 10 μm and is produced by the known technique such as a method in which a metallic compound made of fine particles of, e.g., iron or nickel as a catalyst is allowed to react with a mixed gas of a hydrocarbon gas such as benzene and a carrier gas such as hydrogen at high temperatures. Further, the carbon fibers 16 have a fiber diameter of approximately 10 μm and a fiber length of 100 μm and are produced by the known technique such as carbonization of organic high-molecular fibers. The VGCF 14 and the carbon fibers 16 are melt kneaded with a thermoplastic resin 15 such as PPS (polyphenylene sulfide) to produce the resin composition 13. The resin composition 13 is subjected to injection molding at a low injection rate and molded into the foregoing shape of the movers 11a and 11b.

In the case of this embodiment, the contents of the VGCF 14 and the carbon fibers 16 in the resin composition 13 are each from 5 to 25% by weight, and the total sum of these contents is 30% by weight or less. Incidentally, when the content of the VGCF 14 in the resin composition 13 is higher than that of the carbon fibers 16, since the VGCF 14 that is finer than the carbon fibers 16 is aligned over the whole of each of the movers 11a and 11b, the conductivity and radiation properties of each mover can be enhanced. On the other hand, when the content of the carbon fibers 16 is higher than that of the VGCF 14, since the carbon fibers 16 that are larger than the VGCF 14 are aligned over the whole of each of the movers, the rigidity of each of the movers and the sliding properties of the plural convexes 12 can be enhanced, and the shrinkage during the resin molding can be reduced.

In this embodiment, the fiber length and fiber diameter of the VGCF 14 are not limited to those as described above but can be properly changed. For example, the fiber diameter and the fiber length may be defined at from 1 to 1,000 nm and from 10 nm to 20 μm, respectively. When each of the defined values is too low, the VGCF 14 is coagulated in the resin composition 13, so that it becomes difficult to uniformly disperse and align the VGCF 14 in the resin composition 13. Further, the fiber length and fiber diameter of the carbon fibers 16 are not limited to those as described above but can be properly changed. Tn this case, the respective values may be made higher than those of the VGCF 14, and preferably, the fiber diameter of the carbon fibers 16 is larger than 1,000 nm. Further, the contents of the VGCF 14 and the carbon fibers 16 in the resin composition 13 are not limited to those as described above. However, when the contents of the VGCF 14 and the carbon fibers 16 are too high, since the viscosity of the resin composition 13 increases, there is a possibility that the resin composition 13 is not completely filled in a mold during the injection molding of the resin composition 13.

Tn this embodiment, though the VGCF 14 is used as the first fine carbon fibers, the fine carbon fibers are not limited thereto, but for example, carbon nanotubes or carbon nanofibers may be used. Further, the thermoplastic resin 15 is not limited to PPS but can be properly changed. For example, PA (polyamide) may be used. Moreover, the mixing method of the VGCF 14 and the carbon fibers 16 with the thermoplastic resin 15 is not limited to the melt kneading but may be carried out by, for example, twin-screw kneading.

Though the carbon fibers are used as the second fine carbon fibers, the second fine carbon fibers are not limited thereto but are only required such that the fiber diameter of the second fine carbon fibers is larger than that of the first fine carbon fibers. For example, in the case where the first fine carbon fibers are made of a carbon nanotube having a fiber diameter smaller than that of VGCF, VGCF may be used as the second fine carbon fibers.

Tn this embodiment, the resin composition 13 is subjected to resin molding by injection molding into the shape of the movers 11a and 11b. The resin molding method of the resin composition is not limited thereto but can be properly changed. Further, though the resin composition 13 is subjected to injection molding at a low injection rate, the injection rate may be increased. However, when the injection rate is too high, the VGCF 14 and the carbon fibers 16 in the resin composition 13 are oriented. Accordingly, portions where the respective VGCF 14 and carbon fibers 16 interfere with each other are reduced, so that the conductivity of the movers 11a and 11b may possibly be lowered.

Tn this embodiment, the resin composition 13 is processed into the shape of the movers 11a and 11b by resin molding such as injection molding. The processing method of the movers 11a and 11b is not limited thereto but can be properly changed. For example, the resin composition 13 may be first subjected to injection molding to form into a shape not having an irregular shape (convex 12) on the external surface of the mover, followed by cutting off a portion not corresponding to the convex 12 on the external surface by, for example, laser processing or dicing processing, to form the external surface shape of the movers 11a and 11b.

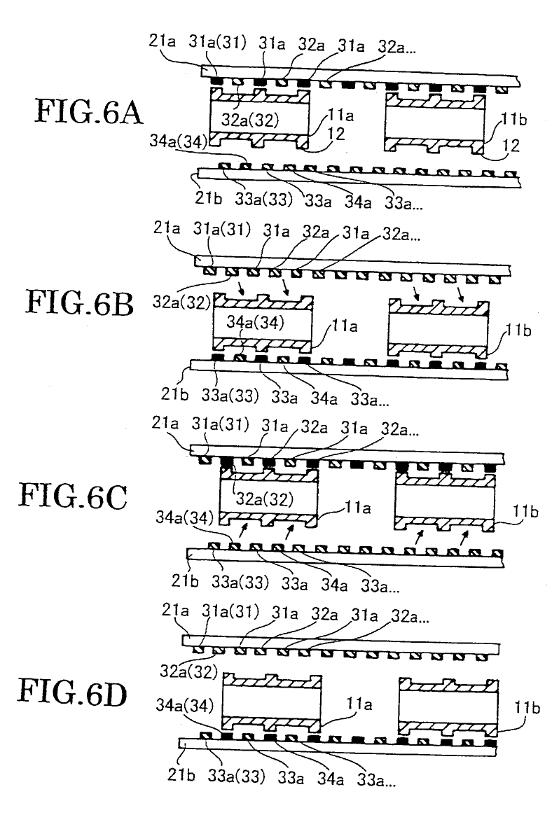

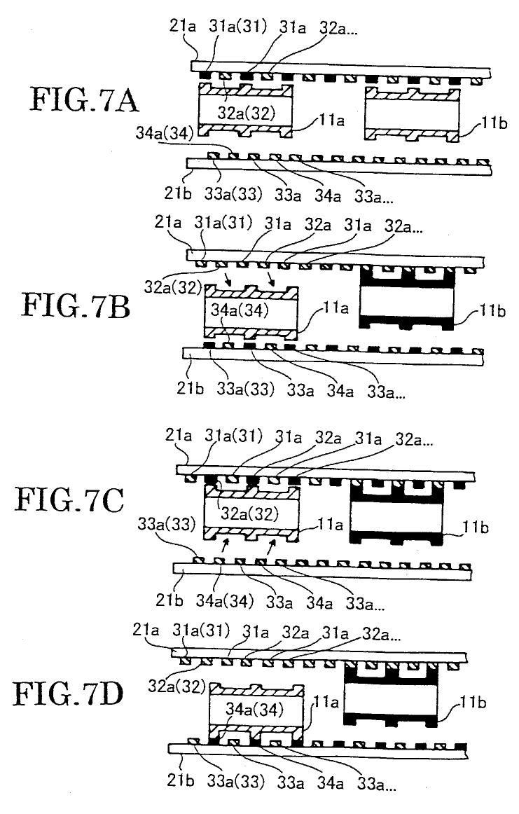

Next, the action of this embodiment having the foregoing construction will be described below. Incidentally, in FIGS. 6 and 7, the portions as painted out black mean that they have a positive potential V; the sites as hatched mean that they have a negative potential −V; and the void sites mean that they have a potential of zero, respectively.

First of all, the case where the mover 11a and the mover 11b are actuated interlockingly each other will be described below with reference to FIG. 6. First, the mover ha and the mover 11b are charged at a prescribed negative potential −V by the power driver 51 via the lead wires 19a and 19b. Incidentally, in the case where the respective movers 11a and 11b are actuated interlockingly each other, the respective movers 11a and 11b may be grounded to have a potential of zero. Since the mover 11a and the mover 11b are subsequently actuated in the same mode, the action of only the mover 11a will be described. The action of the mover 11b is shown in FIG. 6. As described below, in the case where the potential of each of the stator electrodes 31a, 32a, 33a and 34a is switched to +V or −V, it is necessary that the potential of the mover be −V; and in the case that the potential of each of these stator electrodes is switched to +V or zero, it is necessary that the potential of the mover be zero, respectively.

Next, based on a prescribed voltage application signal as generated from a control unit 52, a pulse voltage is applied to each of the first electrode pattern 31, the second electrode pattern 32, the third electrode pattern 33 and the fourth electrode pattern 34 by the power driver 51 via each of the lead wires 41 to 44, whereby the pulse voltage is applied successively to the first electrode pattern 31, the third electrode pattern 33, the second electrode pattern 32 and the fourth electrode pattern 34, and each electrode pattern is successively switched to a prescribed positive potential V. The action of the mover in this case will be described below.

First, in the case where the first electrode pattern 31 of the upper stator 21a has a prescribed positive potential V, each convex 12 of the mover 11a is in the state where it is adsorbed onto the stator electrode 31a of the first electrode pattern 31 as shown in FIG. 6A.

Next, the potential of the first electrode pattern 31 of the upper stator 21a is made to have the same polarity as in the mover, namely, is switched to −V, and simultaneously, the third electrode pattern 33 of the lower stator 21b is switched to a prescribed positive potential V. Here, the electrostatic force is a force in inverse proportion to a square of the distance. For this reason, to each stator electrode 33a of the third electrode pattern 33, is drawn a material present most nearly and having a highest potential difference, namely, the convex 12 (of the mover 11a). Thus, as shown in FIG. 6B, the mover 11a is displaced downwardly in the right side in the drawing.

Next, the potential of the third electrode pattern 33 of the lower stator 21b is switched to −V, and simultaneously, the second electrode pattern 32 of the upper stator 21a is switched to a prescribed positive potential V. Thus, as shown in FIG. 6C, the mover 11a is displaced upwardly in the right side in the drawing according to the same principle as the foregoing operating principle.

Thus, when the potential of each of the first electrode pattern 31, the third electrode pattern 33, the second electrode pattern 32 and the fourth electrode pattern 34 is successively switched from a prescribed negative potential −V to a prescribed positive potential V, the mover 11a transfers to the optical axis A direction (the right direction in FIG. 6) while moving vertically between a pair of the stators 21a and 21b.

Incidentally, similar to the mover 11a, the mover 11b transfers to the optical axis A direction (the right direction in FIG. 6) while moving vertically between a pair of the stators 21a and 21b.

Incidentally, when the order for applying a voltage of a reverse polarity against each of the movers 11a and 11b to each of the electrode patterns 31 to 34 is reversed, it is possible to transfer the movers 11a and 11b to the reverse direction (the left direction in FIG. 6).

Next, as one example of the case where either one of the mover 11a or the mover 11b is actuated singly, while fixing the other, a method in which the mover 11a is actuated, and the mover 11b is fixed will be described below with reference to FIG. 7.

First, the mover 11a and the mover 11b are charged at a prescribed negative potential −V by the power driver 51 via the lead wires 19a and 19b. The potential of the mover 11a is kept at the prescribed negative potential −V.

As described above, when the potential of each of the first electrode pattern 31, the third electrode pattern 33, the second electrode pattern 32 and the fourth electrode pattern 34 is successively switched from a prescribed negative potential −V to a prescribed positive potential V, the mover 11a transfers to the optical axis A direction (the right direction in FIG. 7) while moving vertically between a pair of the stators 21a and 21b.

On the other hand, the potential of the mover 11b is switched corresponding to the change of the potential of each of the electrode patterns 31 to 34. That is, a positive or negative voltage is applied to the mover 11b via the lead wire 19b. The action of the mover 11b in this case will be described below in detail.

First, as shown in Fig. 7A, in the case where the first electrode pattern 31 is made to have a prescribed positive potential V, and the mover 11b is made to have a prescribed negative potential −V, (each convex 12 of) the mover 11b is in the state where it is adsorbed onto the stator electrode 31a of the first electrode pattern 31.

Next, as shown in FIG. 7B, in the case where the third electrode pattern 33 is switched to a prescribed positive potential V, the potential of the mover 11b is switched to a prescribed positive potential V interlocking with this switching. Then, since a state where the potential difference is still present is kept between the mover 11b and the stator electrode 31a of the first electrode pattern 31, each of the convexes 12 of the mover 11b keeps the state where it is continuously adsorbed onto the stator electrode 31a.

Next, as shown in FIG. 7C, even in the case where the second electrode pattern 32 is switched to a prescribed positive potential V, each convex 12 of the mover 11b keeps the state where it is continuously adsorbed onto the stator electrode 31a by an electrostatic force as generated due to the potential difference from the opposing stator electrode 31a.

Next, as shown in FIG. 7D, in the case where the fourth electrode pattern 34 is switched to a prescribed positive potential V, the mover 11b keeps the state where it is continuously adsorbed on the stator electrode 31a by an electrostatic force as generated due to the potential difference from the opposing stator electrode 31a.

As described above, by switching the potential of each of the electrode patterns 31 to 34 in a prescribed order and switching properly the potential of each of the movers 11a and 11b, it is possible to transfer the movers 11a and 11b interlockingly each other or only one of the movers. Accordingly, it becomes possible to regulate the relations of absolution position (this means the position against the stators 21a and 21b) and relative position of the movers 11a and 11b of the electrostatic actuator 3, in which a concave lens 10a and a convex lens 10b constructing the objective optical system are installed, respectively. Accordingly, it is possible to obtain the electrostatic actuator 3 having a focus regulating function and a zooming function (this means an enlargement and reduction function of images taken by the CCD 4). In this case, since a driving source for driving the lenses is an electrostatic force, even in the case where the size is small, it is possible to drive the lenses with a sufficient driving force. Thus, according to this embodiment, it is possible to obtain the high-performance, compact-size electrostatic actuator 3, in its turn the high-performance, compact-size optical device 1.

The movers 11a and 11b are formed of the resin composition 13 containing the VGCF 14, and the conductive VGCF 14 is uniformly dispersed and aligned over the whole of each of the movers, especially even in the plural fine convexes 12 provided on the external surface thereof. Since the VGCF 14 interferes with each other in many portions, it is possible to obtain the cheap movers 11a and 11b that are small in size but have high conductivity.

The VGCF 14 is fine such that the fiber diameter is approximately 200 nm, and it is possible to finely form the size of the plural convexes 12 as provided on the external surface of the each of the movers 11a and 11b at fine intervals (pitch P) between the adjacent convexes 12. Accordingly, it is possible to delicately set up a transfer amount at one revolution of each mover, thereby enabling to make the movement of each mover highly precise.

It is possible to produce the movers 11a and 11b by resin molding. Accordingly, the production is particularly easy as compared with the case where the fine convexes 12 to be formed on the external surface of each mover is made of a metal. Thus, it is possible to obtain the movers 11a and 11b having processability suitable for mass production.

It is also possible to form the convexes 12 of each of the movers 11a and 11b by cutting processing such as laser processing and dicing processing. Accordingly, the shrinkage of each mover, especially the convexes 12, as generated during the production by resin molding can be reduced, so that it is possible to produce the convexes 12 with a high precision as compared with the case of resin molding of each mover.

As described above, according to this embodiment, it is possible to produce the movers 11a and 11b by a different production method including the resin molding suitable for mass production and the cutting processing with a high precision. Thus, it is possible to select the production method according to the characteristics required for each mover, and hence, the degree of freedom of the production method can be enhanced.

The resin composition 13 to form each of the movers 11a and 11b further contains the carbon fibers 16 having a fiber diameter larger than that of the VGCF 14, in addition to the VGCF14. Accordingly, as compared with the case where each mover is made of only the VGCF 14, the rigidity of the mover can be reinforced, the sliding properties in the plural convexes can be enhanced, and the shrinkage of the mover as generated during the resin molding of the mover can be reduced. Also, since the content of the expensive VGCF 14 that is difficult for mass production can be made low, it is possible to produce the resin composition 13 at a low price.

In this embodiment, the number of the movers is not limited to two. For example, the number of the movers may be reduced to one. Further, the number of the movers may be increased, and similar to the foregoing case, the respective movers can be transferred singly or interlockingly each other.

The optical element constructing the objective optical system is not limited to one that is installed in the mover. A non-moving optical element, for example, an optical element fixed to the frame body 20, may be included in the objective optical system.

While in this embodiment, the resin composition 13 is applied as the conductive resin composition to the movers 11a and 11b, the invention is not limited thereto. For example, the resin composition may be applied as the resin composition having high rigidity, sliding properties and radiation properties to toothed gears.

The resin composition of invention contains first fine carbon fibers having a fiber diameter of from 1 to 1,000 nm and second fine carbon fibers having a fiber diameter larger than that of the first fine carbon fibers. Accordingly, the first fine carbon fibers having conductivity are uniformly dispersed and aligned in the resin composition, and the respective fine carbon fibers interfere with each other in many portions, so that a resin composition having high conductivity can be obtained. Further, the first fine carbon fibers are fine such that the fiber diameter is from 1 to 1,000 nm and are uniformly dispersed and aligned even in fine portions. Accordingly, it is possible to impart high conductivity even in fine portions. Moreover, since the second fine carbon fibers having a fiber diameter larger than that of the first fine carbon fibers are further contained, the rigidity of the resin composition can be reinforced, and the sliding properties thereof can be enhanced, as compared with the case where the resin composition is formed of only the first fine carbon fibers. Additionally, since the content of the expensive first fine carbon fibers can be made low, it is possible to obtain a cheaper resin composition.

What is claimed is:

1. A resin composition comprising first fine carbon fibers having a fiber diameter of from 1 to 1,000 nm and second fine carbon fibers having a fiber diameter larger than that of the first fine carbon fibers.

2. The resin composition according to claim 1, wherein the content of the first fine carbon fibers is higher than the content of the second fine carbon fibers.

3. The resin composition according to claim 1, wherein the content of the second fine carbon fibers is higher than the content of the first fine carbon fibers.
